(19) United States
(12) Patent Application Publication
(10) Pub. No.: US 2004/0185878 A1
(43) Pub. Date: Sep. 23, 2004

(54) Device and method for displaying pictures in wireless mobile terminal

(76) Inventor: Jung-Oh Woo, Chilgok-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/765,062

(22) Filed: Jan. 28, 2004

(30) Foreign Application Priority Data
Jan. 30, 2003 (KR) 2003-6421

(51) Int. Cl. H04N 7/14; H04Q 7/20

(52) U.S. Cl. 455/457; 348/14.01; 348/14.02

(57) ABSTRACT

A picture display device in a mobile terminal comprising a direction detecting section for detecting the direction in which the mobile terminal is placed and generating direction detecting signals, and a display controller for outputting display data in an upright direction when a first direction detecting signal is generated, in a direction turned 90° clockwise when a second direction detecting signal is generated, in a direction turned 180° when a third direction detecting signal is generated, and in a direction turned 270° clockwise when a fourth direction detecting signal is generated.

### CROSS-REFERENCE TO RELATED APPLICATIONS

This application claims priority under 35 U.S.C. §119 to an application entitled “Device and Method for Displaying Pictures in Wireless Mobile Terminal” filed in the Korean Intellectual Property Office on Jan. 30, 2003 and assigned Serial No. 2003-6421, the entire content of which is incorporated herein by reference.

### BACKGROUND OF THE INVENTION

1. Field of the Invention

The present invention relates to a device and a method for displaying a picture in a mobile terminal, and more particularly to a device and a method for detecting the direction in which a mobile terminal is placed and controlling the display direction of a picture.

2. Description of the Related Art

It is a current trend that mobile communication terminals are becoming more integrated than existing mobile telephones for voice communication to perform data transmission. For example, IMT-2000 mobile communication network services enable high-speed data transmission as well as voice communication through such mobile terminals. These integrated mobile terminals therefore, can process both packet data and image data in an IMT-2000 network. Mobile terminals equipped with a cameral or a TV receiver can also display moving pictures. A mobile terminal with an embedded camera can take pictures and display them as moving or still pictures, and it is also possible to send the pictures to another mobile terminal. A mobile terminal with a TV receiver can display received video or image signals.

However, typical mobile terminals display pictures in a single fixed direction, regardless of their positions. Accordingly, viewers can see the pictures displayed only in a fixed direction on the mobile terminals. When a terminal is placed at a certain angle relative to the plane on which it stands, the resulting orientation of the displayed pictures does not match that of the pictures perceived by the viewer. More specifically, when a terminal is turned an angle of 90°, pictures displayed are also turned 90°. The viewer has to tilt his or her head to one side at the same angle to see normal pictures.

Accordingly, a need exists for a system and method for controlling the display direction of a picture based upon a detected direction in which a mobile terminal is placed.

### SUMMARY OF THE INVENTION

Accordingly, the present invention has been made to solve the above-mentioned problems occurring in the prior art, and an object of the present invention is to provide a device and a method for automatically controlling the display direction of pictures on a mobile terminal to enable a viewer to see the pictures in an upright position, regardless of the direction in which the mobile terminal is placed.

Another object of the present invention is to provide a mobile terminal comprising sensors for detecting the display direction of pictures and which is capable of controlling the display direction according to an output from the sensors, thereby consistently producing the pictures in an upright direction, regardless of the direction in which the terminal is placed.

Another object of the present invention is to provide a method for controlling the display direction in the mobile terminal according to an output from the sensors.

Still another object of the present invention is to provide a device and a method for displaying a picture on a mobile terminal in an upright direction as perceived by the eyes of a viewer, regardless of the direction in which the terminal is placed, and for adjusting the size of the picture according to the direction of a display section of the terminal.

These and other objects are substantially achieved by providing a mobile terminal having a direction detecting section for detecting the direction in which the mobile terminal is placed and generating first to fourth direction detecting signals, and a display controller for outputting display data to a display in an upright direction when a first direction detecting signal is generated, in a direction turned 90° when a second direction detecting signal is generated, in a direction turned 180° when a third direction detecting signal is generated, and in a direction turned 270° when a fourth direction detecting signal is generated.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing the structure of an example mobile communication terminal according to a first embodiment of the present invention;

FIG. 2 is a plan view showing the structure of an example display section of the mobile terminal in FIG. 1;

FIG. 3 is a plan view showing an example direction detecting section of the mobile terminal in FIG. 1;

FIG. 4 is a flow chart showing an example process of controlling a displaying operation of a mobile terminal according to an embodiment of the present invention;

FIG. 5 is a flow chart showing another example of a process of controlling a displaying operation of a mobile terminal according to an embodiment of the present invention; and

FIG. 6 is a block diagram of an example mobile communication terminal according to a second embodiment of the present invention.

### DETAILED DESCRIPTION OF THE PREFERRED EMBODIMENTS

Hereinafter, preferred embodiments of the present invention will be described with reference to the accompanying drawings. Although certain elements, such as a display section (i.e. size), are specifically defined in the following description of the present invention, it will be obvious to those skilled in the art that such definitions are merely to improve understanding of the present invention and that the present invention can be carried out with various modifications.

In the following description of the present invention, an example mobile terminal with a camera or a TV receiver is presented and described. However, the present invention is equally applicable to all general mobile phones which may not include a camera or a TV receiver.

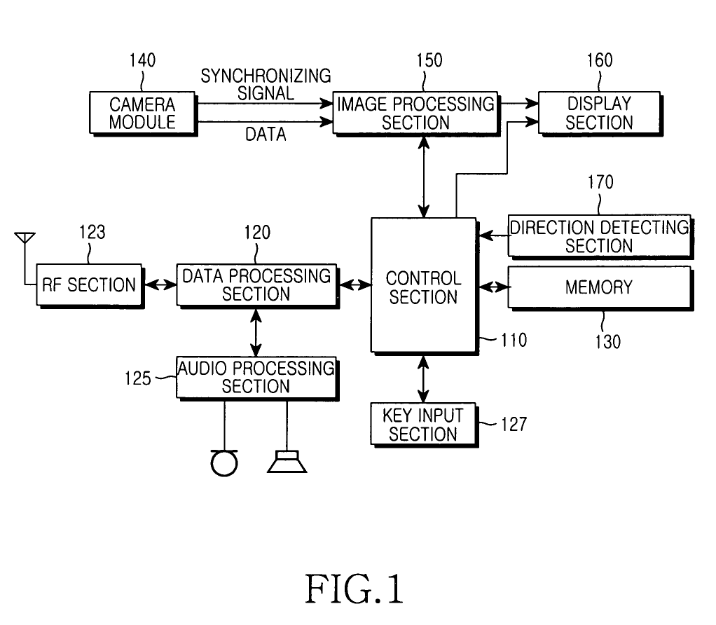

FIG. 1 is a block diagram showing the structure of an example mobile communication terminal equipped with a camera according to the first embodiment of the present invention.

Referring to FIG. 1, an RF section 123 performs a wireless communication function of a mobile terminal. The RF section 123 comprises a RF transmitter for performing upward conversion and amplification of the frequency of a signal which is being transmitted, and an RF receiver for amplifying a signal, which is being received, with low noise and performing downward conversion of the frequency of the signal. A data processing section 120 comprises a transmitter for coding and modulating a signal which is being transmitted, and a receiver for demodulating and decoding a signal which is being received. The data processing section 120 may be comprised of a modem and a codec. The codec comprises a data codec for processing packet data and a sound codec for processing a sound signal such as a speech signal. An audio processing section 125 reproduces an audio signal output from the audio codec of the data processing section 120 or transmits an audio signal generated from a microphone to the audio codec of the data processing section 120.

A key input section 127 is provided with keys for inputting numbers and characters and function keys for setting up various functions. The key input section 127 may additionally include a picture direction control key for manually controlling the display direction of pictures. A memory 130 may be comprised of a program memory and a data memory. The program memory includes programs for controlling the display direction of pictures on the mobile terminal to enable a viewer to see the pictures in an upright position. Also, the data memory can temporarily store data generated during implementation of the above programs.

A control section 110 controls the overall operations of the mobile terminal. The control section 110 may also include the data processing section 120. The control section 110 detects the display direction of pictures and controls the mobile terminal to display the pictures in an upright direction as perceived by the eyes of the viewer.

A camera module 140 is used to take pictures of an object on which its lens is focused. The camera module 140 comprises a camera sensor for converting a photographed optical signal into an electric signal and a signal processor for converting an analog image signal photographed by the camera sensor into digital data. In the example where the camera sensor is a charge coupled device(CCD) sensor, the signal processor can be a digital signal processor(DSP). The camera sensor and the signal processor can be either integrated into a single element or separated as independent elements.

An image processing section 150 generates picture data for displaying an image signal output from the camera module 140. The image processing section 150 processes image signals output from the camera module 140 in frames. Also, the image processing section 150 adjusts the frame image data to conform to the features, such as size and resolution, which are displayable on the display section 160, and outputs the adjusted frame image data.

The image processing section 150 comprises an image codec, and functions to compress the frame image data displayed on the display section 160 in a preset manner or restore the compressed frame image data to the original frame image data. The image codec is selected from a variety of still or moving picture codecs, such as JPEG codec, MPEG4 codec or Wavelet codec.

The image processing section 150 also includes an on screen display(OSD) function. The image processing section 150 can output OSD data according to the displayed picture size under the control of the control section 110.

The display section 160 displays image data output from the image processing section 150 or user data output from the control section 110. The display section 160 can be an LCD comprising an LCD controller, a memory for storing image data and an LCD device. When the LCD is a touch screen, it can serve as an input section.

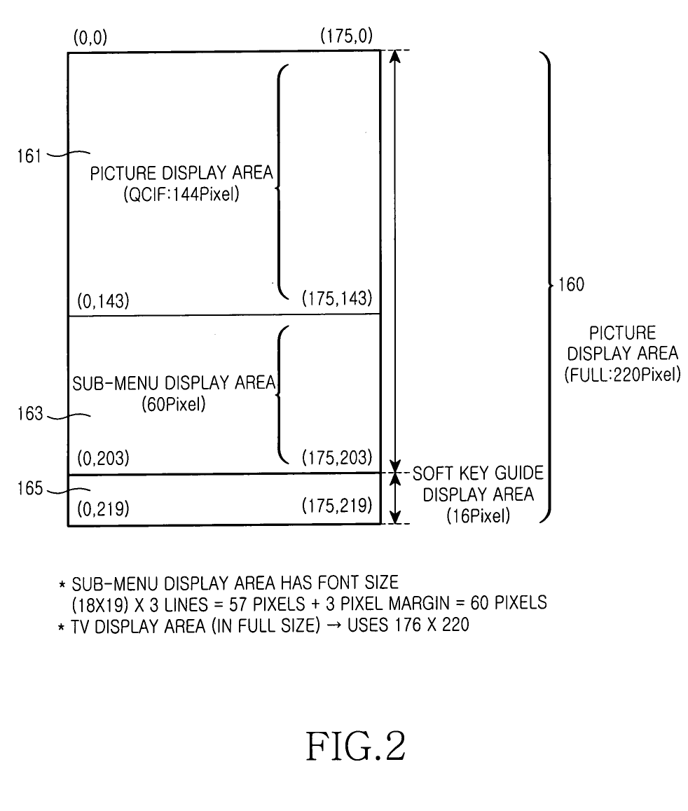

FIG. 2 shows the structure of the display section 160 according to an embodiment of the present invention.

Referring to FIG. 2, the display section 160 has a first display area 161 for displaying image signals and a second display area 163 for displaying user data. The display section 160 may additionally have a third display area 165 for displaying information about soft keys for setting up a menu to enter a display mode. In the first embodiment of the invention, the example of the display section 165 includes all of the first to third display areas 161 to 165. The first display area 161 displays an image in QCIF size. The second display area 163 displays user data. The third display area displays information for guiding soft keys. In this example, the three display areas of the display section 160 have different sizes as shown in FIG. 2. The first display area 161 displays a QCIF picture having 176×144 pixels in a normal state. Also, in this example, a full picture displayed on the entire display section 160 has 176×220 pixels.

Where the second display area 163 has a size of 176×60 pixels, which is a font size (18×19 pixels)×3 lines, character data consisting of 60 characters (i.e. pixels) can be displayed in the second display area 163. If a margin corresponding to a size of 3 characters is given, a total of 57 characters can be displayed. If user data and menus are stored in the memory 131 according to such characteristics of the second display area 163, they can be effectively displayed in the picture display mode.

The picture display mode refers to a mode showing image data photographed by a camera module of a mobile camera phone, or television signals received by a TV receiver-equipped mobile terminal. The photographed image data or the television signals are displayed in the first display area 161. The user data related to the display is shown in the second display area 163.

Returning to FIG. 1, a direction detecting section 170 is provided to detect in what direction the mobile terminal is placed or turned, and output a direction detecting signal to the control section 110. The direction detecting section 170 can be formed in a diversity of structures. In the first embodiment of the invention, the example direction detecting section 170 has four direction sensors for detecting four directions of the display section 160 of the mobile terminal., wherein the direction sensors are Hall sensors (i.e. Hall effect ICs).

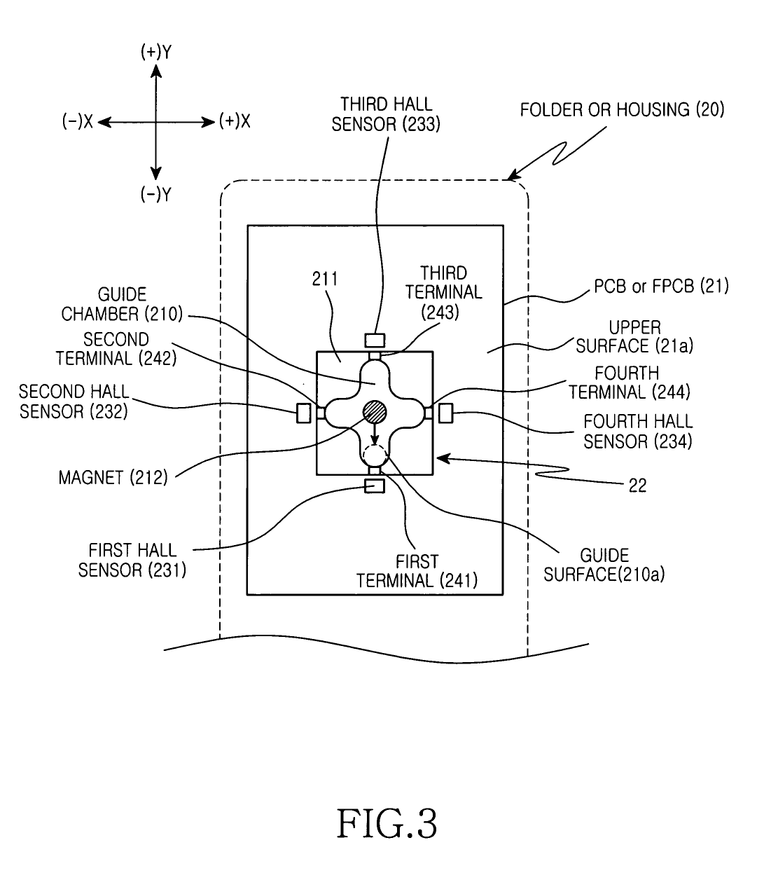

FIG. 3 is a plan view showing the structure of the direction detecting section 170 according to an embodiment of the present invention.

Although the direction detecting section 170 as shown in FIG. 3 is mounted in a folder 20, it can be mounted in a housing of the main body of the mobile terminal. There is no limitation to the position of the direction detecting section 170. That is, the direction detecting section 170 can be mounted in either the folder or the housing of the main body, regardless of the position of the display section 160. For explanatory convenience, the directions (+)X, (−)X, (+)Y and (−)Y in FIG. 3 refer respectively to right (fourth direction, 270° counter-clockwise), left (second direction, 90° counter-clockwise), upward (first direction, 0°) and downward (third direction, 180°), respectively.

The direction detecting section 170 is fixed to the upper surface 21a of a printed circuit board (PCB) 21 on which the display section 160 is mounted. However, the direction detecting section 170 can also be fixed to the lower surface of the printed circuit board 21. Also, the printed circuit board 21 can be replaced with a flexible printed circuit board (FPCB).

The direction detecting section 170 is comprised of a magnetic guide element 22 connected to the printed circuit board 21 and a plurality of Hall sensors 231 through 234 positioned adjacent to the magnetic guide element 22. The magnetic guide element 22 is a flat type and is comprised of a guide chamber 210 in a predetermined shape, a magnet 212 located within the guide chamber 210 and a frame 211 for supporting the guide chamber 210. The magnetic guide element 22 is made of glass and mounted in a predetermined position on the printed circuit board 21. The guide chamber 210 is a cross-shaped space extending outwardly in four directions to allow the magnet 212 to move upward, downward, left and right due to the force of gravity. Preferably, the cross-shaped guide chamber 210 has a curved guide side 210a in order to let the magnet 212 float freely.

The magnet 212 has a ball shape or a cylindrical shape. The magnet 212 moves within the guide chamber 210 under the influence of gravity. The magnet 212 moves to the direction in which the mobile terminal is placed or tilted, and more particularly to the direction of pictures displayed on the display section 160. In the position as shown in FIG. 3, the magnet 212 is shown in broken line as it moves downward to the lower extending portion of the guide chamber 210 due to the force of gravity. A Hall sensor activated by the downward movement of the magnet 212 outputs a direction detecting signal informing the direction of the mobile terminal, and particularly the data display direction of the display section.

A plurality of terminals are provided at the ends of the extending portions of the guide chamber 210 to support the guide chamber 20.

Preferably, the guide chamber 210 should be filled with fluid in order to allow the magnet 212 to move smoothly between positions. For example, viscous fluid can be used. Fluid with high viscosity can slow the movement of the magnet 212 and safely guide the magnet 212.

Also, first to fourth Hall sensors 231 to 234, respectively, are positioned adjacent to the ends of the four extending portions of the guide chamber 210. The Hall sensors 231 to 234 are spaced from the corresponding ends of the four extending portions within such a distance that they can detect a magnetic field emitted from the magnet 212. The Hall sensors 231 to 234 refer to magnetic sensors which are most generally used as proximity sensors for detecting a magnetic field.

The magnet 212 moves within the guide chamber 210 under the influence of gravity according to the direction in which the mobile terminal and particularly the display section are placed. The magnet 212 comes closer to a Hall sensor adjacent to the extending portion to which it has moved. The adjacent Hall sensor outputs a direction detecting signal due to the position of the magnet 212. The first Hall sensor 231 detects the first direction. The second Hall sensor 232 detects the second direction. The third Hall sensor 233 detects the third direction. The fourth Hall sensor 234 detects the fourth direction.

The operation of the mobile terminal having the structure as shown in FIG. 1 will be explained in more detail with reference to FIGS. 2 and 3. When the folder is opened, the control section 110 controls the display section 160 to be in a display mode. The display mode includes both a communication mode and a mode for displaying image data photographed by the camera module 140.

In the display mode, the Hall sensors 231 to 234 of the direction detecting section 170 detects the position of the magnet 212 according to the direction in which the mobile terminal is placed. The magnet 212 moves within the guide chamber 210 to the direction in which the mobile terminal is placed. The magnet 212 is then detected by an adjacent Hall sensor. Assuming that the mobile terminal can be placed in any of the four directions, four Hall sensors 231 to 234 are provided in the four directions in this embodiment of the present invention.

The control section 110 determines the positional state (i.e. direction) of the mobile terminal from the output of the direction detecting section 170. If an output from the first Hall sensor 231 is detected, the control section 110 will determine that the mobile terminal is placed in a normal upright position (i.e. +Y). If an output from the second Hall sensor 232 is detected, the control section 110 will determine that the mobile terminal is turned 90° counter-clockwise (i.e. −X). If an output from the third Hall sensor 233 is detected, the control section 110 will determine that the mobile terminal is turned 180° upside down (i.e. −Y). If an output from the fourth Hall sensor 234 is detected, the control section 110 will determine that the mobile terminal is turned 270° counter-clockwise (i.e. +X).

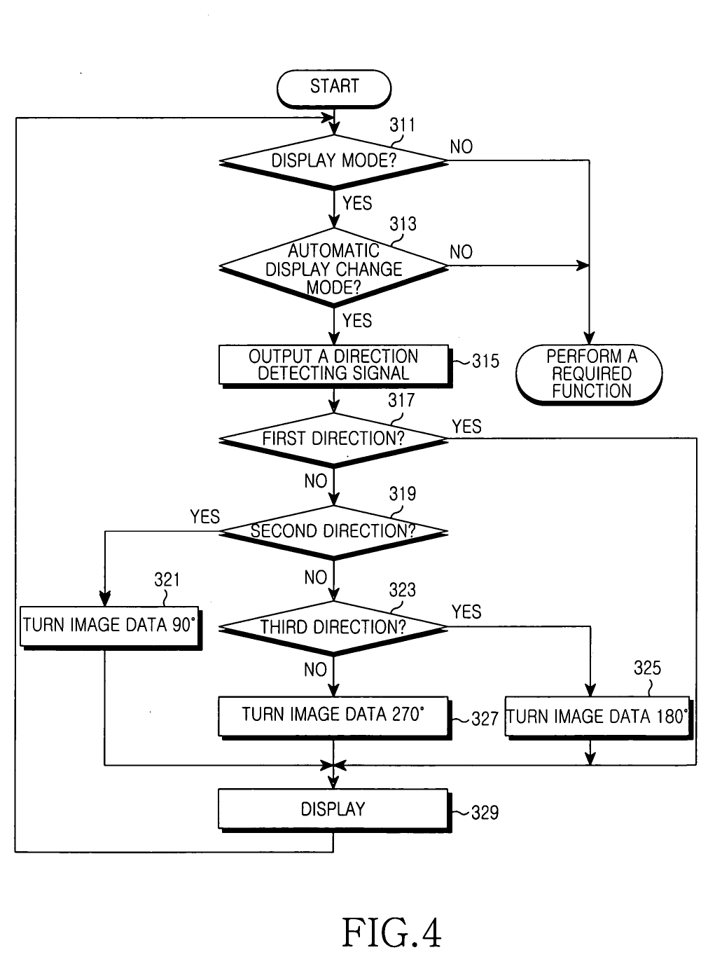

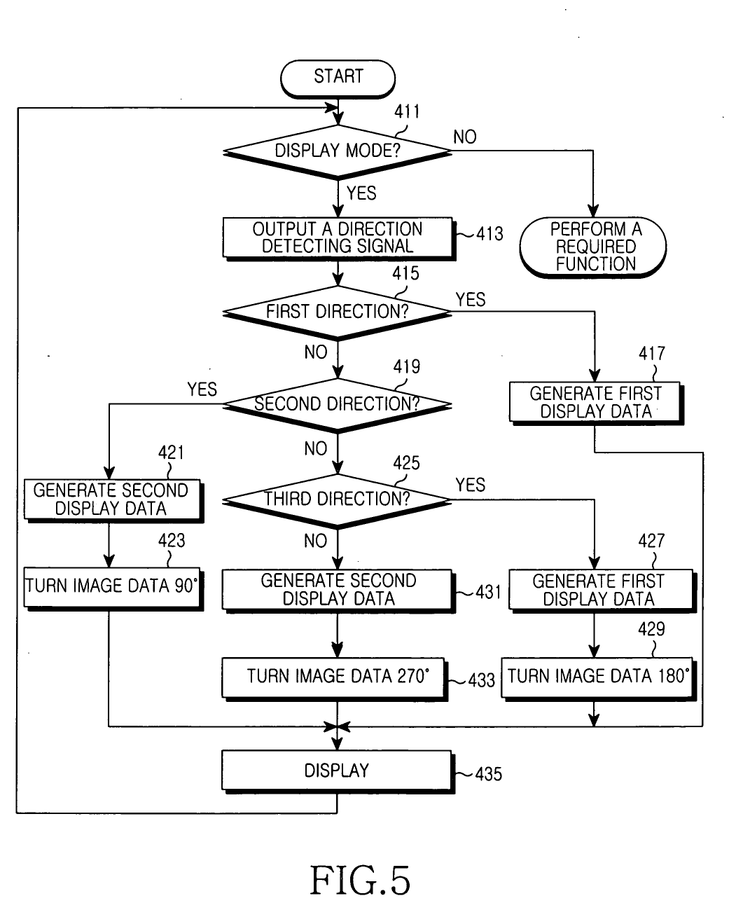

The control section 110 controls the direction of a picture to be displayed on the display section 160 according to the output from the direction detecting section 170. The process of controlling the display direction of the display section 160 will be explained in more detail with reference to FIGS. 4 and 5.

FIG. 4 is a flow chart showing an example process of displaying a picture on a mobile terminal according to an embodiment of the present invention.

Referring to FIG. 4, the control section 110 determines whether the mobile terminal is in the display mode at step 311. The display mode refers herein to a mode of displaying a picture on the display section 160 when the folder housing is opened to be rotated from the main housing. Generally, the first display area 161 displays the initial setting, while the second display area 163 displays the date and time of the day, and the third display area 165 displays the receiving sensitivity and the amount of remaining battery power. In a camera mode, an image photographed by the camera module 140 is processed through the image processing section 150 and displayed in the first display area of the display section 160. In a data communication mode and particularly in a character data communication mode, the first to third display areas 161 to 165 are all used to display character data. When an image mail is received, the first display area 161 displays the received image signal. As stated above, the first display area 161 displays an image in QCIF size.

At step 313, the control section 110 detect if an automatic display change mode is set in the display mode. The automatic display change mode refers to a mode of automatically controlling the direction of a picture displayed on the display section 160 according to a direction detecting signal output from the direction detecting section 170. If the automatic display change mode is not set, the control section 110 will display pictures only in a fixed direction (i.e. first direction, 0°), regardless of the output from the direction detecting section 170.

If the control section 110 detects the setting of the automatic display change mode at step 313, it will lead the direction detecting section 170 to output a direction detecting signal at step 315. Since the direction detecting section 170 has the structure as shown in FIG. 3, the direction detecting signal is an output from any of the first to fourth Hall sensors 231 to 234. If the magnet 212 moves to a first terminal 241 of the guide chamber 210, the first Hall sensor 231 will be driven to generate a first direction detecting signal. At this time, the other Hall sensors 232 to 234 will not generate any direction detecting signal. The generation of the first direction detecting signal means that the mobile terminal is placed in an upright position and displays a picture in an upright direction. The control section 110 detects the first direction detecting signal at step 317 and controls the display section 160 to display a picture in the upright direction at step 329.

If the magnet 212 moves to a second terminal 242, the second Hall sensor 232 will be driven to generate a second direction detecting signal. The other Hall sensors 231, 233 and 234 will not generate any direction detecting signal. The control section 110 will then detect the second direction detecting signal at step 319. The generation of the second direction detecting signal means that the mobile terminal is turned 90° counter-clockwise and initially displays a picture in a direction turned 90° counter-clockwise. The picture should be turned 90° clockwise to be seen in the upright direction as perceived by the eyes of the viewer. Accordingly, upon detecting the second direction detecting signal at step 319, the control section 110 turns the image data applied to the display section 160 90° clockwise to be seen in the upright direction at step 321. At step 329, the control section 110 controls the display section 160 to display the picture in a direction turned 90° clockwise. Thus, the viewer can see the picture in the upright position even when the mobile terminal is turned 90° counter-clockwise.

If the magnet 212 moves to a third terminal 243, the third Hall sensor 233 will be driven to generate a third direction detecting signal. The other Hall sensors 231, 232 and 234 will not generate any direction detecting signal. The control section 110 will then detect the third direction detecting signal at step 323. The generation of the third direction detecting signal means that the mobile terminal is turned 180° and initially displays a picture upside down. The picture should be turned 180° again to be seen in the upright direction. Accordingly, upon detecting the third direction detecting signal at step 323, the control section 110 turns the image data applied to the display section 160 180° to be seen in the upright direction at step 325. At step 329, the control section 110 controls the display section 160 to display the picture in a direction turned 180°. Thus, the viewer can see the picture in the upright position even when the mobile terminal is turned 180° upside down.

If the magnet 212 moves to a fourth terminal 244, the fourth Hall sensor 234 will be driven to generate a fourth direction detecting signal. The other Hall sensors 231 to 233 will not generate any direction detecting signal. The control section 110 will then detect the fourth direction detecting signal at step 323. That is, if the first direction is not detected at step 317, the second direction is not detected at step 319, and the third direction is not detected at step 323, the mobile terminal is assumed to be in the fourth direction. However, an additional detection step (not shown) may be added between step 323 and step 327 in FIG. 4 to specifically detect the fourth direction. The generation of the fourth direction detecting signal means that the mobile terminal is turned 270° counter-clockwise and initially displays a picture in a direction turned by the same angle. The picture should be turned 270° clockwise to be seen in the upright direction. Accordingly, upon detecting the fourth direction detecting signal at step 323, the control section 110 turns the image data applied to the display section 160 270° clockwise to be seen in the upright direction at step 327. At step 329, the control section 110 controls the display section 160 to display the picture in a direction turned 270° clockwise. Thus, the viewer can see the picture in the upright position even when the mobile terminal is turned 270°.

As described above, the direction detecting section 170 detects the direction in which the mobile terminal is placed, and turns the displayed image data on the display section 160 in the opposite direction so as to be seen in the upright direction. The viewer can always see pictures in the upright position, regardless of the direction of the mobile terminal. However, there may be difficulties in displaying a particular size of pictures when the mobile terminal is placed in the second or fourth direction. A picture taken by the camera module can be normally displayed in QCIF size when the mobile terminal is placed upright or turned in the third direction. However, it is difficult to display the picture in QCIF size when the mobile terminal is turned in the second or fourth direction. In such a case, it is preferable to display the picture in a full size.

When the mobile terminal is placed upright or turned in the third direction, image data in a fixed size, such as QCIF size, is displayed only after control of the direction of the visual display. When the mobile terminal is turned in the second or fourth direction, it is preferable to adjust and regenerate the size of such image data and control the direction of the visual display.

FIG. 5 is a flow chart showing another example of a process of controlling the display of a picture on a mobile terminal according to an embodiment of the present invention. In this example, the image data is controlled to be displayed in QCIF size in the first or third direction and in a full size in the second or fourth direction.

Referring to FIG. 5, the control section 110 determines whether the mobile terminal is in the display mode at step 411. The display mode refers herein to a mode of displaying a picture on the display section 160 when the folder housing is opened to be rotated from the main housing. The display mode in FIG. 5 is the same as that in FIG. 4. If the control section 110 detects the display mode at step 411, it will lead the direction detecting section 170 to output a direction detecting signal at step 413. Since the direction detecting section 170 has the structure as shown in FIG. 3, the direction detecting signal can be an output from any of the Hall sensors 231 to 234.

If the magnet 212 moves to the first terminal 241, the first Hall sensor 231 will be driven to generate a first direction detecting signal. At this time, the other Hall sensors 232 to 234 will not generate any direction detecting signal. The generation of the first direction detecting signal means that the mobile terminal is placed upright and displays a picture in an upright direction. The control section 110 detects the first direction detecting signal at step 415 and generates data in QCIF size as first display data at step 417. At step 435, the control section 110 controls the display section 160 to display a picture in the upright direction.

If the magnet 212 moves to the second terminal 242, the second Hall sensor 232 will be driven to generate a second direction detecting signal. The other Hall sensors 231, 233 and 234 will not generate any direction detecting signal. The control section 110 will detect the second direction detecting signal at step 419. The generation of the second direction detecting signal means that the mobile terminal is turned 90° counter-clockwise and initially displays a picture in a direction turned 90° counter-clockwise. The picture should then be turned 90° clockwise so that the viewer can see it in the upright position. Also, the display section 160 should generate second display data to display a full size picture rather than a QCIF size picture. Upon detecting the second direction detecting signal at step 419, the control section 110 controls the display section 160 to generate the second display data in a full size at step 421. At step 423, the control section 110 turns the second display data 90° clockwise to be seen in the upright direction. At step 435, the control section 110 controls the display section 160 to display the second display data in a direction turned 90° clockwise. Thus, the viewer can see the picture in the upright position even when the mobile terminal is turned 90° counter-clockwise.

If the magnet 212 moves to the third terminal 243, the third Hall sensor 233 will be driven to generate a third direction detecting signal. The other Hall sensors 231, 232 and 234 will not generate any direction detecting signal. The control section 110 will detect the third direction detecting signal at step 425. The generation of the third direction detecting signal means that the mobile terminal is turned 180° and initially displays a picture upside down. The picture should be turned 180° again to be seen in the upright direction. Accordingly, upon detecting the third direction detecting signal at step 425, the control section 110 generates first display data in QCIF size at step 427. At step 429, the control section 110 turns the first display data applied to the display section 160 180° to be seen in the upright direction. At step 435, the control section 110 controls the display section 160 to display the picture in a direction turned 180°. Thus, the viewer can see the picture in the upright position even when the mobile terminal is turned 180° upside down.

If the magnet 212 moves to the fourth terminal 244, the fourth Hall sensor 234 will be driven to generate a fourth direction detecting signal. The other Hall sensors 231 to 233 will not generate any direction detecting signal. The control section 110 will then detect the fourth direction detecting signal at step 425. That is, if the first direction is not detected at step 415, the second direction is not detected at step 419, and the third direction is not detected at step 425, the mobile terminal is assumed to be in the fourth direction. However, an additional detection step (not shown) may be added between step 425 and step 431 in FIG. 5 to specifically detect the fourth direction. The generation of the fourth direction detecting signal means that the mobile terminal is turned 270° counter-clockwise and initially displays a picture in a direction turned by the same angle. The picture should be turned 270° clockwise to be seen in the upright direction. Also, the display section 160 should generate second display data to display a full size picture, rather than a QCIF size picture. Upon detecting the second direction detecting signal at step 425, the control section 110 controls the display section 160 to generate the second display data in a full size at step 431. At step 433, the control section 110 turns the second display data applied to the display section 160 270° clockwise to be seen in the upright direction. At step 435, the control section 110 controls the display section 160 to display the second display data in a direction turned 270° clockwise. Thus, the viewer can see the picture in the upright position even when the mobile terminal is turned 270°.

A mobile terminal capable of controlling image data according to the procedure as shown in FIG. 5 can have the structure as shown in FIG. 1. In other words, a mobile terminal having a general communication function, including character data communication, can implement the process as shown in FIG. 4 by controlling the direction of the visual display of data according to the direction of the mobile terminal, without the need to adjust the size of the data. A mobile terminal equipped with a camera, i.e., a camera phone, displays image data photographed by the camera (i.e. camera module 140) in a fixed size which is suitable to be displayed in the first direction. When the image data is displayed in the second or fourth direction, its size preferably should be adjusted.

A mobile terminal equipped with a TV receiver has a similar structure as a camera phone.

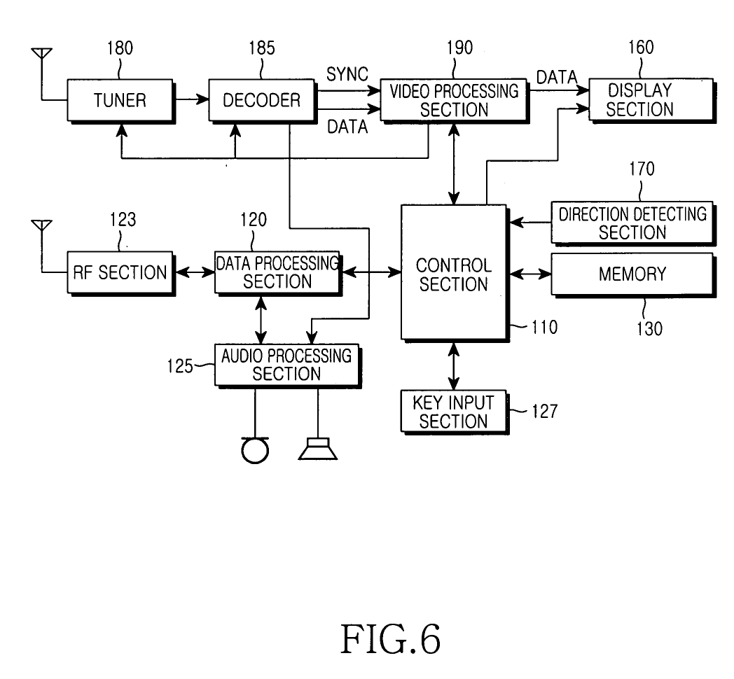

FIG. 6 is a block diagram showing the structure of an example mobile terminal equipped with a TV receiver according to the second embodiment of the present invention. The mobile terminal can be a mobile telephone.

Referring to FIG. 6, the RF section 123 performs a wireless communication function of a mobile telephone. The RF section 123 comprises a RF transmitter for performing upward conversion and amplification of the frequency of a signal which is being transmitted, and an RF receiver for amplifying a signal, which is being received, with low noise and performing downward conversion of the frequency of the signal. The data processing section 120 comprises a transmitter for coding and modulating a signal which is being transmitted, and a receiver for demodulating and decoding a signal which is being received. The data processing section 120 may be comprised of a modem and a codec. The audio processing section 125 reproduces an audio signal output from the data processing section 120 or transmits an audio signal generated from a microphone to the data processing section 120. Also, in a television mode, the audio processing section 125 reproduces audio signals included in television signals output from a decoder 185.

The keypad 127 is provided with keys for inputting numbers and characters and function keys for setting up various functions. Also, the keypad 127 includes various mode setting keys for processing television signals. The memory 130 may be comprised of a program memory and a data memory. The program memory includes programs for controlling general operations of the mobile telephone and those for displaying the television video signals according to the present invention. Also, the data memory can temporarily store data generated during implementation of the above programs.

The control section 110 controls the overall operations of the mobile terminal and may include the data processing section 120. The control section 110 controls a video processing section 190 to enter the television mode or the communication mode according to the mode selection from the keypad 127. When the television mode is selected, the control section 110 controls the video processing section 190 to display received television video signals and outputs user data in the television mode to the video processing section 190. When the communication mode is selected, the control section 110 controls the video processing section 190 to operate in the communication mode or the OSD mode and outputs user data in the communication mode to the video processing section 190. When voice communication is performed in the communication mode, the control section 110 blocks a path of television audio signals output from the decoder 185. In addition, the control section 110 receives a direction detecting signal output according to the direction in which the mobile terminal is placed, and controls the direction of the visual display of data.

A tuner 180 receives television video signals broadcast on a selected channel under the control of the control section 110. The tuner 180 performs a frequency conversion of the received television video signals. The decoder 185 demodulates and decodes the composite television video signals output from the tuner 180. The decoder 185 separates audio signals and video signals from the composite video signals and decodes the separated audio and video signals which are then sent to the audio processing section 125 and the video processing section 190, respectively. Also, the decoder 185 decodes the television video signals and outputs color signals (i.e. R, G and B) and synchronizing signals.

The video processing section 190 performs data communication with the control section 110. According to the control of the control section 110, the video processing section 190 processes signals to display user data output from the control section 110 and television video signals output from the decoder 185. In the television mode, the video processing section 190 processes video signals output from the decoder 185 and user data output from the control section 110 and outputs them to a corresponding display area of the display section 160. The user data, which includes the present time, the receiving sensitivity and the amount of remaining battery power, can be called state data showing any change of state in the television mode.

The video processing section 190 processes the television video signals in frames and outputs the television video signals and the user data separately. Also, the video processing section 190 can offer a communication service in the television mode or the OSD mode. When communication is performed in the television mode, the video processing section 190 simultaneously outputs the television video data and the user data in the communication mode output from the control section 110. When communication is performed in the OSD mode, the video processing section 190 blocks the television video data and displays the user data in the communication mode output from the control section 110. At this time, the user data can be a text message or subscriber information.

In the communication mode, the display section 160 displays data output from the control section 110. In the television mode, the display section 160 displays television video data output from the video processing section 190 and user data in corresponding display areas. Specifically, the television video data is displayed in the first display area, while the user data is displayed in the second display area. The display section 160 may additionally have a third display area for displaying soft keys, such as menus. In the television mode, the display section 160 displays television video signals in the first display area and the user data in the communication mode in the second display area. In the OSD mode, the display section 160 displays the user data in the communication mode in both the first display area and the second display area. The display section 160 can be an LCD comprising an LCD controller, a memory for storing image data and an LCD device. Where the LCD is provided as a touch screen, it can serve as an input section together with the keypad 127. The display section 160 divides the display area into three as shown in FIG. 2 to display the television video signals and the user data.

The direction detecting section 170 detects in what direction the mobile terminal is placed or turned and outputs a direction detecting signal to the control section 110. The direction detecting section 170 can be formed having a number of structures. In the second embodiment of the invention, the example direction detecting section 170 has four direction sensors for detecting four directions of the display section 160 of the mobile terminal, wherein the direction sensors are Hall sensors (i.e. Hall effect ICs). The direction detecting section 170 can be configured as shown in FIG. 3.

The operation of the mobile terminal having the structure as shown in FIG. 6 will be described in more detail with reference to FIGS. 2 and 3. When the folder housing is opened to be rotated from the main housing, the control section 110 controls the display section 160 to be in the display mode. The display mode includes both a communication mode and a mode for displaying television video data.

In the display mode, the control section 110 outputs channel control data selected by the user to the tuner 180. According to the data, the tuner 180 tunes the channel selected by the user and performs downward conversion of the frequency of the received channel signals. The decoder 185 decodes the audio and video signals of the selected channel. The decoded video signals are sent to the video processing section 190, while the decoded audio signals are sent to the audio processing section 125. After processing the decoded video signals to be displayed on the display section 160, the video processing section 190 outputs the processed video signals to the display section 160. At this time, the video processing section 190 generates video signals in QCIF size or a full size under the control of the control section 190.

The Hall sensors 231 to 234 of the direction detecting section 170 detects the position of the magnet 212 that moves according to the direction in which the mobile terminal is placed. The magnet 212 moves within the guide chamber 210 to the direction in which the mobile terminal is placed. The magnet 212 is then detected by an adjacent Hall sensor. Assuming that the mobile terminal can be placed in any of the four directions, four Hall sensors 231 to 234 are provided in the four directions in this embodiment of the present invention.

The control section 110 determines the positional state (i.e. direction) of the mobile terminal from the output of the direction detecting section 170. If an output from the first Hall sensor 231 is detected, the control section 110 will determine that the mobile terminal is placed in a normal upright direction. If an output from the second Hall sensor 232 is detected, the control section 110 will determine that the mobile terminal is turned 90° counter-clockwise. If an output from the third Hall sensor 233 is detected, the control section 110 will determine that the mobile terminal is turned 180° upside down. If an output from the fourth Hall sensor 234 is detected, the control section 110 will determine that the mobile terminal is turned 270°.

The control section 110 controls the direction of a picture to be displayed on the display section 160 according to the output from the direction detecting section 170. The process of controlling the display direction of the display section 160 is shown in FIG. 5.

As described above, the present invention can detect the direction in which a mobile terminal is placed and adjust the display direction of pictures to enable a viewer to see the pictures in an upright position. The viewer can always see the pictures in an upright position, regardless of the direction in which the mobile terminal is placed. Also, the size of data displayed on the display section can be adjusted according to the direction of the mobile terminal.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A picture display device in a mobile terminal, comprising:
a direction detecting section for detecting the direction in which the mobile terminal is placed and generating first, second, third and fourth direction detecting signals;
a display controller for outputting display data in an upright direction when a first direction detecting signal is generated, in a direction turned 90° clockwise when a second direction detecting signal is generated, in a direction turned 180° when a third direction detecting signal is generated, or in a direction turned 270° clockwise when a fourth direction detecting signal is generated; and
a display section for displaying the display data.

2. The picture display device according to claim 1, wherein said direction detecting section comprises:
a guide chamber having first, second, third and fourth extending portions corresponding respectively to the first, second, third and fourth directions;
a magnet disposed within the guide chamber and moving to any of the first, second, third and fourth extending portions according to the direction in which the mobile terminal is placed; and
first, second, third and fourth Hall sensors positioned adjacent to the ends of the first, second, third and fourth extending portions to detect a magnetic field emitted from the magnet and generate corresponding first, second, third and fourth direction detecting signals.

3. The picture display device according to claim 1, wherein said direction detecting section is mounted in a folder housing of the mobile terminal.

4. The picture display device according to claim 1, wherein said direction detecting section is mounted in a main housing of the mobile terminal.

5. A picture display device in a mobile terminal comprising:
a camera module for taking an image signal;
an image processing section for processing the image signal taken by the camera module in a display picture size;
a direction detecting section for detecting the direction in which the mobile terminal is placed and generating first, second, third and fourth direction detecting signals;
a display controller for outputting display data in an upright direction when a first direction detecting signal is generated, in a direction turned 90° clockwise when a second direction detecting signal is generated, in a direction turned 180° when a third direction detecting signal is generated, or in a direction turned 270° clockwise when a fourth direction detecting signal is generated; and
a display section for displaying the display data.

6. A picture display device in a mobile terminal comprising:
a tuner for receiving a composite television video signal broadcast on a selected channel;
a decoder for decoding the composite video signal to generate an analog video signal and a synchronizing signal;
a video processing section for converting the analog video signal into a digital video data, processing the digital video data in a frame size and outputting a frame video signal and user data in the frame;
a direction detecting section for detecting the direction in which the mobile terminal is placed and generating first, second, third and fourth direction detecting signals;
a display controller for outputting display data in an upright direction when a first direction detecting signal is generated, in a direction turned 90° clockwise when a second direction detecting signal is generated, in a direction turned 180° when a third direction detecting signal is generated, or in a direction turned 270° clockwise when a fourth direction detecting signal is generated; and
a display section for displaying the display data.

7. A method for displaying a picture on a mobile terminal, comprising the steps of:
detecting the direction in which the mobile terminal is placed;
outputting and displaying display data in an upright direction when a first direction is detected;
outputting and displaying the display data in a direction turned 90° clockwise when a second direction is detected;
outputting and displaying the display data in a direction turned 180° when a third direction is detected; and
outputting and displaying the display data in a direction turned 270° clockwise when a fourth direction is detected.

8. A method for displaying a picture on a mobile terminal, comprising the steps of:
detecting the direction in which the mobile terminal is placed;
outputting and displaying display data in an upright direction when a first direction is detected;
generating full size display data and displaying the display data in a direction turned 90° clockwise when a second direction is detected;
outputting and displaying the display data in a direction turned 180° when a third direction is detected; and
generating full size display data and displaying the display data in a direction turned 270° clockwise when a fourth direction is detected.
